(19) United States
(12) Patent Application Publication
(10) Pub. No.: US 2021/0004524 A1
(43) Pub. Date: Jan. 7, 2021

(54) CATALOG FILE CREATION ASSISTANCE DEVICE, CATALOG FILE CREATION ASSISTANCE METHOD, AND CATALOG FILE CREATION ASSISTANCE PROGRAM

(71) Applicant: Nippon Telegraph and Telephone Corporation, Tokyo (JP)

(72) Inventors: Kensuke Takahashi, Tokyo (JP); Hiroyuki Yazaki, Tokyo (JP); Hiroshi Kato, Tokyo (JP); Nobuo Onai, Tokyo (JP); Hiroyuki Tanaka, Tokyo (JP)

(21) Appl. No.: 16/977,759

(22) PCT Filed: Mar. 6, 2019
(86) PCT No.: PCT/JP2019/008775

§ 371 Date: Sep. 2, 2020

(30) Foreign Application Priority Data
Mar. 12, 2018 (JP) 2018-044547

(51) Int. Cl. G06F 40/14; G06F 40/174; G06F 16/16; G06F 40/137

(52) U.S. Cl. CPC G06F 40/14; G06F 40/137; G06F 16/168; G06F 40/174

(57) ABSTRACT

[Problem] To assist editing work of a plurality of relevant catalog files.

[Solution] A catalog file creation assistance device (1) includes a definition file management unit (13) configured to store a definition file, the definition file defining information of a relevant catalog file and an attribute described in the catalog file for each catalog file, a catalog file creation assistance UI generation unit (22) configured to generate a catalog creation screen (213) for each catalog file to be created, the catalog creation screen (213) including a link for calling the catalog creation screen (213) for creating the relevant catalog files described in the definition file, and an input field for each attribute described in the definition file, and a catalog file creation assistance UI unit (21) configured to receive an input of an attribute value in the input field for each attribute via the catalog creation screen (213), and register the catalog file to be created including the received attribute value in a catalog file management unit (23).

### TECHNICAL FIELD

The present invention relates to a catalog file creation assistance device, a catalog file creation assistance method, and a catalog file creation assistance program.

### BACKGROUND ART

JavaScript Object Notation (JSON) and YAML Ain't a Markup Language (YAML) have been proposed as data formats that are structured appropriately while still being easy for humans to read. These data formats (hereinafter “catalog files”) are adopted in the following fields, for example.

Standard format describing an API using Open API Initiative aimed at description standardization of Representational State Transfer (REST) Application Programming Interface (API)

Configuration template of configuration management tools such as Ansible

Orchestration template format of Infrastructure as a Service (IaaS) such as OpenStack and Amazon Web Services (AWS)

Configuration file for automatically constructing a calculation resource environment

Tools that assist editing of catalog files are also published on the web. An online editor in Non Patent Literature 1 provides an editing assistance functions for coloring keywords or performing a tree display according to a data structure to facilitate editing JSON format files.

An online editor in Non Patent Literature 2 provides a function of creating a page for entering a HyperText Markup Language (HTML) form from a prepared JSON schema and outputting a JSON format file on the basis of attribute values entered in the entry page.

### CITATION LIST

### Non Patent Literature

Non Patent Literature 1: “JSON Editor Online”, [online], [retrieved Feb. 27, 2018], Internet (URL: http://jsoneditoronline.org/)
Non Patent Literature 2: GitHub. Inc, “JSON Schema Based Editor”, [online], 2018, [retrieved Feb. 27, 2018], Internet (URL: https://github.com/jdorn/json-editor)

### SUMMARY OF THE INVENTION

### Technical Problem

Although a catalog file may be completed with only one file, one object may often be achieved using a set of a plurality of catalog files. For example, an operation such as describing only an outline of setting content in a first catalog file and describing a portion of the setting content in a second catalog file in detail is performed. In this case, a catalog file that has been created and a catalog to be created both present, and an editor has to manually carefully manage which catalog files are to be created.

However, human-caused editing errors in catalog files such as omissions may occur due to increasingly complicated editing process such as a large-scale set of catalog files or participation of a plurality of editors. An online editor of the related art can assist editing of a single catalog file so that it is easy to read, but a relationship between catalog files has not been taken into account.

Thus, an object of the present invention is to assist editing of a plurality of relevant catalog files.

### Means for Solving the Problem

In order to solve the problem, a catalog file creation assistance device of the present invention has the following characteristics.

The present invention is a catalog file creation assistance device including: a definition file management unit configured to store a definition file, the definition file defining information of a catalog file relevant to a catalog file to be created and an attribute described in the catalog file to be created, for each catalog file to be created; a screen generation unit configured to generate a catalog creation screen for each catalog file to be created by referring to the definition file, the catalog creation screen including a link for calling the catalog creation screen for creating the relevant catalog files, and an input field for each attribute described in the catalog file to be created; and a screen input unit configured to receive an input of an attribute value in the input field for each attribute via the catalog creation screen, and register the catalog file to be created including the received attribute value in a catalog file management unit.

Thereby, a catalog creation screen in which editing work between catalog files is interlinked on the basis of a relationship between the catalog files described in the definition file is provided. Thus, even when the catalog file creator does not know the relationship between the catalog files, it is possible to assist in editing work in which a plurality of relevant catalog files are targets.

In the present invention, a catalog file, which becomes part of components of the catalog file to be created, is described in the definition file as information of the relevant catalog file.

As a result, the catalog creation screen in which editing work between catalog files is interlinked is provided for a plurality of catalog files having a composition relationship (entirety and part).

In the present invention, a catalog file having an attribute value, which is referred to by the catalog file to be created, is described in the definition file as information of the relevant catalog files.

Thereby, the catalog creation screen in which editing work between catalog files is interlinked is provided for a plurality of catalog files having a reference relationship between attribute values.

In the present invention, requirement information indicating whether description in the catalog file is required for each attribute is defined in the definition file, and the screen generation unit displays an attribute included in the catalog creation screen to be created, with the requirement information added.

This allows the catalog file creator to input a required attribute value without omission.

In the present invention, a plurality of candidate values that are taken for each attribute are defined in the definition file, and the screen generation unit sets an input field for an attribute included in the catalog creation screen to be created as an input field for selecting one candidate value from the plurality of candidate values.

This can prevent an error of an input of candidate values by the catalog file creator.

### Effects of the Invention

According to the present invention, it is possible to assist in editing work in which a plurality of relevant catalog files are targets.

### BRIEF DESCRIPTION OF DRAWINGS

FIG. 1 is a configuration diagram of a catalog file creation assistance device according to the present embodiment.

FIG. 2 is an illustrative diagram illustrating processing content of a catalog file creation assistance UI generation unit according to the embodiment.

FIG. 3 is a diagram illustrating a relationship between catalog files stored in a catalog file management unit according to the embodiment.

FIG. 4 is a diagram illustrating various screens transitioning when a new creation button has been selected on a menu screen according to the embodiment.

FIG. 5 is a diagram illustrating various screens transitioning when an update button, a deletion button, and an output button have been selected on the menu screen according to the embodiment according to the embodiment.

FIG. 6 is an illustrative diagram of a definition file stored in a definition file management unit according to the embodiment.

FIG. 7 is a sequence diagram illustrating a process of registering a definition file in a definition file management unit according to the embodiment.

FIG. 8 is a sequence diagram illustrating until a menu screen is displayed according to the embodiment.

FIG. 9 is a sequence diagram until a catalog creation screen is displayed from a menu screen displayed in a process of FIG. 8 according to the embodiment.

FIG. 10 is a sequence diagram until a catalog file created on the catalog creation screen displayed in a process of FIG. 9 according to the embodiment is registered in the catalog file management unit.

### DESCRIPTION OF EMBODIMENTS

An embodiment of the present disclosure will be described below with reference to the drawings.

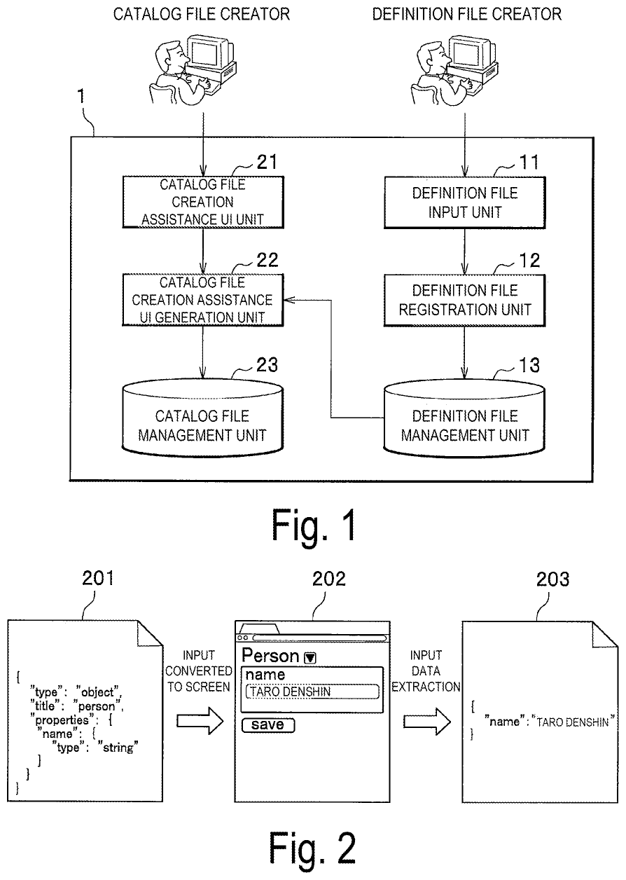

FIG. 1 is a configuration diagram of a catalog file creation assistance device 1.

The catalog file creation assistance device 1 is configured as a computer including a central processing unit (CPU), a memory, a storage means (a storage unit) such as a hard disk, and a network interface.

The CPU executes a program (also referred to as an application or an app which is an abbreviation therefor) read into the memory, and thus, the computer operates a control unit (control means) including various processing units.

The catalog file creation assistance device 1 includes a definition file input unit 11, a definition file registration unit 12, a definition file management unit 13, a catalog file creation assistance UI unit 21, a catalog file creation assistance UI generation unit 22, and a catalog file management unit 23.

A definition file is a file that defines a screen for creating a catalog file. First, the definition file registration unit 12 registers the definition file input via the definition file input unit 11 by a definition file creator in the definition file management unit 13.

The catalog file creation assistance UI generation unit 22 generates an input screen of a graphical user interface (GUI) that the catalog file creation assistance UI unit 21 presents to the catalog file creator, on the basis of the definition file loaded from the definition file management unit 13.

The catalog file creator can easily edit the catalog file to be registered in the catalog file management unit 23 using the catalog file creation assistance UI unit 21.

The catalog file is obtained by grouping one or more pairs of an attribute (Attribute) and an attribute value (Value) of the attribute as one file. For example, description of “ ”id”: “12”” of the catalog file indicates a pair in which an attribute value of an attribute “id” is “12”.

FIG. 2 is an illustrative diagram illustrating processing content of the catalog file creation assistance UI generation unit 22.

The catalog file creation assistance UI generation unit 22 generates a form input screen 202 in an HTML FORM format, or the like from a JSON schema 201, which is a definition file read from the definition file management unit 13. In the form input screen 202, an input field for an attribute value according to a type property (string type, Boolean type, or the like) of attributes listed up in the definition file is automatically generated.

For example, “person” that is a title described in the JSON schema 201 is displayed in an upper portion of the form input screen 202. A one-line text box “name” is located in the form input screen 202 in order to cause an attribute “name” of the string type described in the JSON schema 201 to be input.

On the other hand, because the Boolean type may take a value of any of true and false, a radio button for selecting any one of two options is located on the form input screen (not illustrated).

When an attribute value such as a name “Taro Denshin” is input from the catalog file creator via the form input screen 202, the catalog file creation assistance UI unit 21 substitutes the attribute defined in the catalog file with the input attribute value, thereby generating JSON output data 203 serving as a catalog file. The generated catalog file is stored in the catalog file management unit 23.

Thus, when the catalog file creator inputs a pair of an attribute and an attribute value, the catalog file creator may simply input the attribute value to the input field for an attribute value via the form input screen 202 instead of inputting text data in which the attribute and the attribute value have been written together. This allows grammar errors of the catalog file to be reduced through prevention of input errors of structured symbols such as commas or parentheses for pairing the attribute and the attribute value.

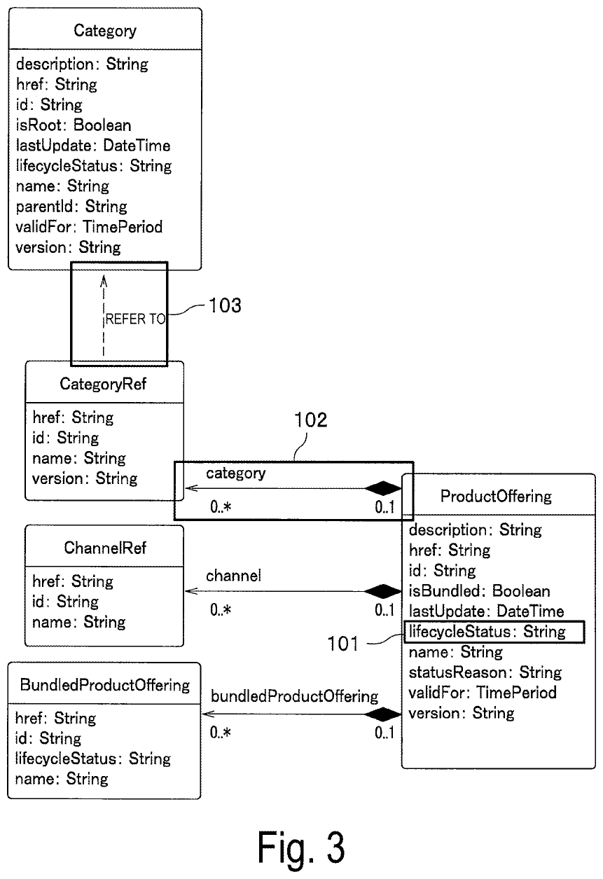

FIG. 3 is a diagram of relationships between catalog files stored in the catalog file management unit 23.

One catalog file has a configuration in which a catalog name (for example, “ProductOffering”) and an attribute list included in the catalog (for example, an attribute “lifecycleStatus” of a String type indicated by reference numeral 101) are divided up and down by a horizontal line.

A composition relationship indicated by a connection line 102, a reference relationship between the attribute values indicated by a connection line 103, and the like are defined as a relationship between the catalog files connected by an arrow.

First, the connection line 103 will be described. When a catalog name is “˜Ref” like “CategoryRef”, the catalog file thereof is a reference source catalog in which the attribute value is used as an external reference value. Each attribute value of a reference source catalog is substituted with an attribute value of a reference destination catalog connected by an arrow. For example, a value of an attribute “href” in “CategoryRef” is substituted with an attribute value of an attribute “href” in “Category” that is a reference destination, as indicated by the connection line 103.

Next, the connection line 102 will be described. A black diamond is described on the “ProductOffering” side of the connection line 102, and a tip of the arrow is described on the “CategoryRef” side. A notation of this arrow indicates a composition relationship in which a catalog at the start point of the arrow indicates the entirety and a catalog pointed by an arrow is part of the entirety. Multiplicity is set at both ends of the connection line 102.

The multiplicity of “0 . . . 1” on the “ProductOffering” side of the connection line 102 indicates that one “CategoryRef” is relevant to “0 . . . 1” (that is, zero or one) “ProductOffering”. The multiplicity of “0 . . . *” on the “CategoryRef” side of the connection line 102 indicates that one “ProductOffering” is relevant to “0 . . . *” (that is, zero or more) “CategoryRef”.

That is, one “ProductOffering” has zero or more “CategoryRef” as part of components and one “CategoryRef” is part of zero or one “ProductOffering”.

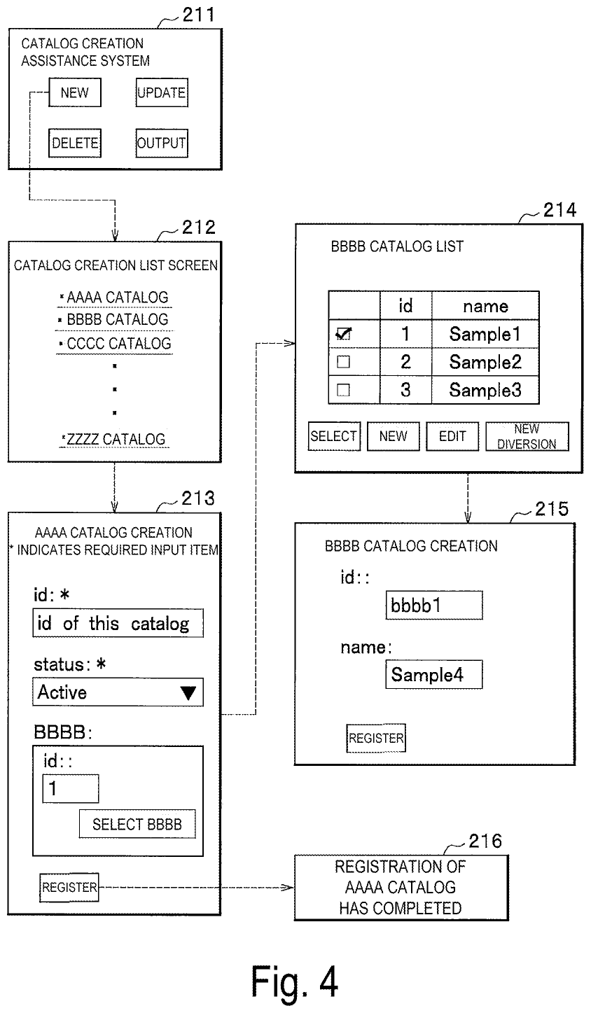

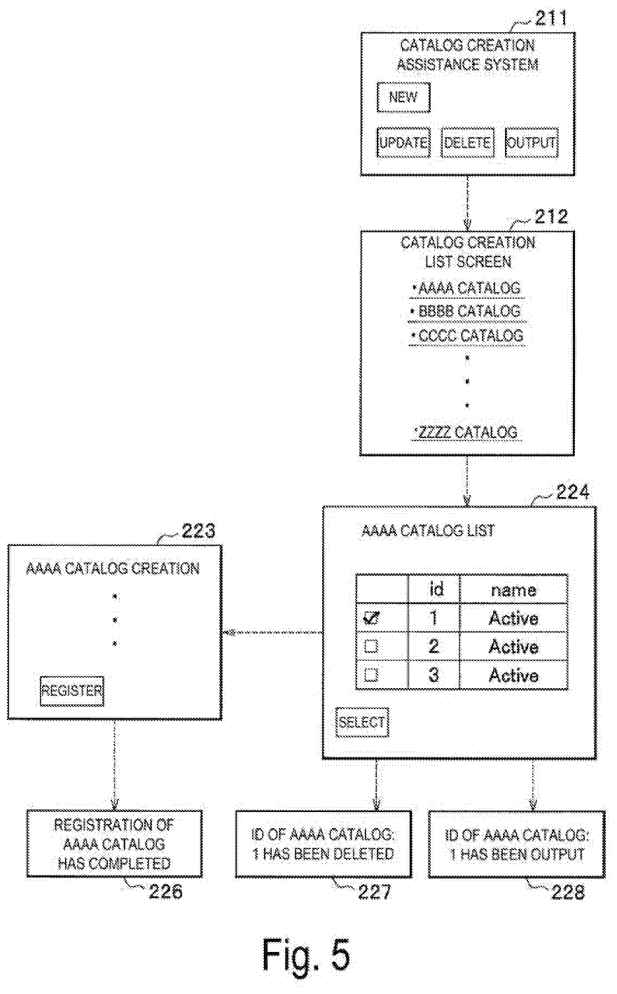

Hereinafter, each screen that the catalog file creation assistance UI generation unit 22 generates in order to create the catalog file, which has been described as the form input screen 202 in FIG. 2 will be described in detail with reference to FIG. 4 and FIG. 5. FIG. 4 is a diagram illustrating various screens transitioning when a new creation button has been selected in a menu screen 211 for creating a catalog file.

Buttons for respective operations for the catalog file are located as a new creation button, an update button, a deletion button, and an output button in the menu screen 211. When the new creation button is pressed on the menu screen 211, transition to a catalog creation list screen 212 occurs.

For a catalog file to be created, links for respective catalog types described in the definition file are located as an AAAA catalog, a BBBB catalog, a CCCC catalog, . . . , and a ZZZZ catalog in the catalog creation list screen 212. When the AAAA catalog is pressed on the menu screen 211, transition to a catalog creation screen 213 occurs.

The catalog creation screen 213 is a form in which content of the AAAA catalog, which is a catalog file to be created, is entered. The catalog creation screen 213 includes an input field for an attribute (id, status) that the AAAA catalog holds therein, an input field for another catalog file (a BBBB catalog) relevant to the AAAA catalog, and a registration button that is pressed when the input is complete. The attribute id is provided with a mark indicating that the item requires input.

When the registration button is pressed, creation of the catalog file of the AAAA catalog is completed, and the catalog file including the attribute value input on the screen is registered in the catalog file management unit 23.

That is, the catalog creation screen 213 is a main editing screen in a screen set that constitutes the form input screen 202.

Thus, attribute values listed up in the definition file are reflected in the catalog creation screen 213 generated by the catalog file creation assistance UI generation unit 22 without omission. That is, not only the input field for the attribute (id, status) that is defined inside the AAAA catalog, which is a creation target, but also the input field for the BBBB catalog relevant to the AAAA catalog is prepared in the catalog creation screen 213.

Therefore, the catalog file creator can avoid omission of entry even if the catalog file creator does not remember what attribute the AAAA catalog has and which other catalog the AAAA catalog is relevant to.

A description display “id of this catalog” is displayed as a default value of the attribute value in an input field for the attribute “id” in the catalog creation screen 213.

The catalog file creator can input the attribute value by referring to the displayed description display.

This allows the catalog file creator to easily create the catalog file because the catalog file creator can ascertain a meaning of the attribute value.

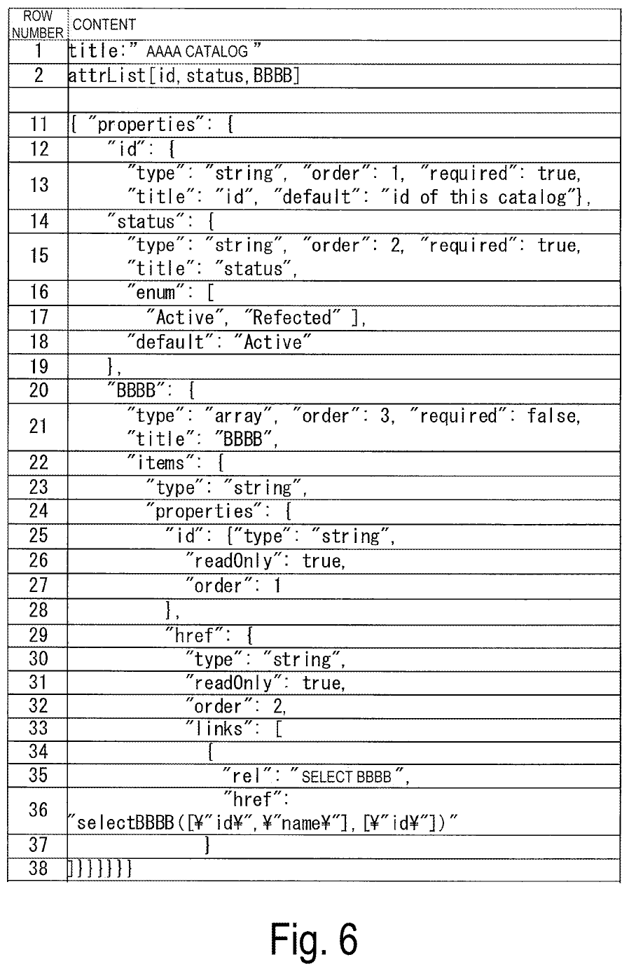

A pull-down menu for selecting one attribute value from a candidate list of attribute values including an attribute value “Active” is located as the input field for the attribute “status” of the catalog creation screen 213. Therefore, the catalog file creation assistance UI generation unit 22 loads a “candidate value” (to be described below in FIG. 6)” of the definition file as a candidate list in advance and adds a pull-down menu for selecting one candidate from the candidate list to the catalog creation screen 213.

This allows the catalog file to be easily created through prevention of input errors such as spelling errors, as compared with a scheme of directly inputting attribute values in a text format.

Here, it is assumed that the fact that the BBBB catalog is cited as an item “Refer to other file” of the AAAA catalog has been defined in the definition file in advance. That is, a reference from a reference source catalog to a reference destination catalog is defined as described using the connection line 103 in FIG. 3.

Thus, a button for selecting BBBB, which is a reference destination catalog, and a display field for id “1” of the BBBB catalog selected as a reference destination by pressing the button are located in the input field for an attribute “BBBB” of the catalog creation screen 213.

A display example after id “1” of the BBBB catalog has already been selected is illustrated in FIG. 4, and an operation until id “1” of the BBBB catalog is selected will be described hereinafter.

When the button for selecting BBBB is pressed on the catalog creation screen 213, transition to a catalog list screen 214 occurs. On the catalog list screen 214, a list of catalog files already registered as the BBBB catalog in the catalog file management unit 23 is displayed in a table format. This table includes a check field indicating which catalog file is selected, and a combination field for a different id and name for each catalog file.

The catalog file creator can check a check field of id “1” and press a selection button in a lower portion of the table to input id “1” of the BBBB catalog of the catalog creation screen 213. Alternatively, the catalog file creator can check the check field of id “1” and press an editing button in the lower portion of the table to edit (update) the checked catalog file.

Further, the catalog file creator may desire to create a catalog file with a new id that is not present in the table of the catalog list screen 214. In this case, the catalog file creator presses a new button or a new diversion button on the lower portion of the table, thereby transitioning to a catalog creation screen 215 of a new id. When the new diversion button has been pressed, an initial value of an attribute value of the catalog creation screen 215 is substituted with the attribute value of another catalog file (which is a diversion source) selected in the check field for the catalog list screen 214.

The catalog creation screen 215 is a screen on which two attributes (id, name) of the BBBB catalog are input. When the registration button is pressed, creation of the catalog file of the catalog BBBB is completed, and the catalog file including the attribute value input on the screen is registered in the catalog file management unit 23.

As described above, a mechanism for calling the catalog list screen 214 or the catalog creation screen 215 of the relevant BBBB catalog is prepared as a part of the catalog creation screen 213 for the AAAA catalog. That is, the catalog file creation assistance UI generation unit 22 loads information indicating a relationship between a plurality of catalog files from the definition file, and reflects the relationship in the catalog creation screen 213 of the catalog file creation assistance UI unit 21.

This allows the catalog file creator to easily ascertain the relationship between the plurality of catalog files and to create a plurality of relevant catalog files together.

Although the reference relationship described using the connection line 103 in FIG. 3 has been illustrated in FIG. 4 as the relationship between the plurality of catalog files, any relationship such as the composition relationship described using connection line 102 may be reflected in the catalog creation screen 213. This allows the catalog file creator to collectively edit a set of a plurality of catalog files without omission when one object is achieved using the set of a plurality of catalog files.

FIG. 5 is a diagram illustrating various screens transitioning when the update button, the deletion button, or the output button have is selected in the menu screen 211. When the “update button” is pressed, the catalog file creation assistance UI unit 21 allows the type of the catalog file that is an update target to be selected via the catalog creation list screen 212. The catalog file creation assistance UI unit 21 allows a catalog file that is an update target to be selected via a catalog list screen 224 belonging to the selected type (the AAAA catalog) of catalog file, enabling transition to a catalog creation screen 223 of the catalog file.

Further, the catalog file creation assistance UI unit 21 displays a message screen 226 indicating that the catalog file updated via the catalog creation screen 223 has been registered in the catalog file management unit 23.

When the “deletion button” has been pressed, the catalog file creation assistance UI unit 21 allows the type of catalog file which is a deletion target to be selected via the catalog creation list screen 212. The catalog file creation assistance UI unit 21 allows the catalog file which is a deletion target to be selected via the catalog list screen 224 belonging to the selected type (the AAAA catalog) of catalog file.

Further, the catalog file creation assistance UI unit 21 displays a message screen 227 indicating that the catalog file has been deleted from the catalog file management unit 23.

When the “output button” is pressed, the catalog file creation assistance UI unit 21 causes the type of catalog file that is an output target to be selected via the catalog creation list screen 212. The catalog file creation assistance UI unit 21 allows the catalog file which is an output target to be selected via the catalog list screen 224 belonging to the selected type (the AAAA catalog) of catalog file.

Further, the catalog file creation assistance UI unit 21 displays a message screen 228 indicating that the catalog file read from the catalog file management unit 23 has been output. An output destination of the catalog file is, for example, screen display or export to a file.

FIG. 6 is an illustrative diagram of a definition file stored in the definition file management unit 13. The definition file is a text file. In FIG. 6, row numbers are given for ease of illustration.

Row number 1 indicates the type (the AAAA catalog) of catalog file.

In row number 2, attributes included in the catalog file are listed up. For example, a list “BBBB” of an external relevant catalog is also listed up, in addition to an attribute list “id, status” included within the catalog.

The catalog file creation assistance UI generation unit 22 reflects the type of catalog file and the attribute included in the catalog file in the catalog creation screen 213.

For a detailed definition of each attribute, a definition of attribute id is described in row numbers 12 and 13, a definition of attribute status is described in row numbers 14 to 19, and a relationship with an external catalog BBBB is described in row numbers 20 to 37.

The following property is defined for each attribute. The properties may be one value or may be content of an arrangement in which a plurality of values are grouped.

A “type property” is defined as “type”: “string” in row number 13 (the type property is a character string type). The catalog file creation assistance UI generation unit 22 reflects the type property in an input means (text input, check selection, or the like) for each attribute of the catalog creation screen 213.

“Description order” is defined as ‘order“: 1” (description order is first) in row number 13, for example. The catalog file creation assistance UI generation unit 22 reflects the description order in display order of the attribute of the catalog creation screen 213.

“Required” is defined as “ ”required“: true” in row number 13 (in first description order). The catalog file creation assistance UI generation unit 22 uses a mark “*” of a required input item of the catalog creation screen 213 to indicate that the input is required.

A “display name” is defined as “ ”title”: “id” in row number 13 (display name is id). The catalog file creation assistance UI generation unit 22 reflects the display name in the attribute name (id, status, BBBB) of the catalog creation screen 213.

A “default value” is defined as “ ”default”: “id of this catalog”” in row number 13 (the default value is “id of this catalog”). The catalog file creation assistance UI generation unit 22 reflects the default value as an initial value of the attribute input field of the catalog creation screen 213.

A “candidate value” is defined as “ ”enum“: [”Active“, “Reflected”]” in row numbers 16 and 17 (“Active, Reflected” are listed as candidate values). The catalog file creation assistance UI generation unit 22 reflects the candidate value in an option of the pull-down menu of the catalog creation screen 213.

A relationship with the other catalog file is, for example, the composition relationship indicated by the connection line 102, or the reference relationship between the attribute values indicated by the connection line 103. Such a relationship is defined in an item link in row numbers 33 to 36 as “Refer to other file”, for example.

In row number 35, a link display character string “Select BBBB” of the catalog creation screen 213 is defined.

In row number 36, a selectBBBB function that is called when “Select BBBB” is pressed is defined. The selectBBBB function is a function for generating, on the catalog creation screen 213, a link for displaying two attributes (id, name) described in a first argument (see the catalog creation screen 215) and allowing the attribute id described in a second argument to be input (see the catalog list screen 214).

The catalog file creation assistance UI generation unit 22 reflects a link generated by the selectBBBB function in the catalog creation screen 213.

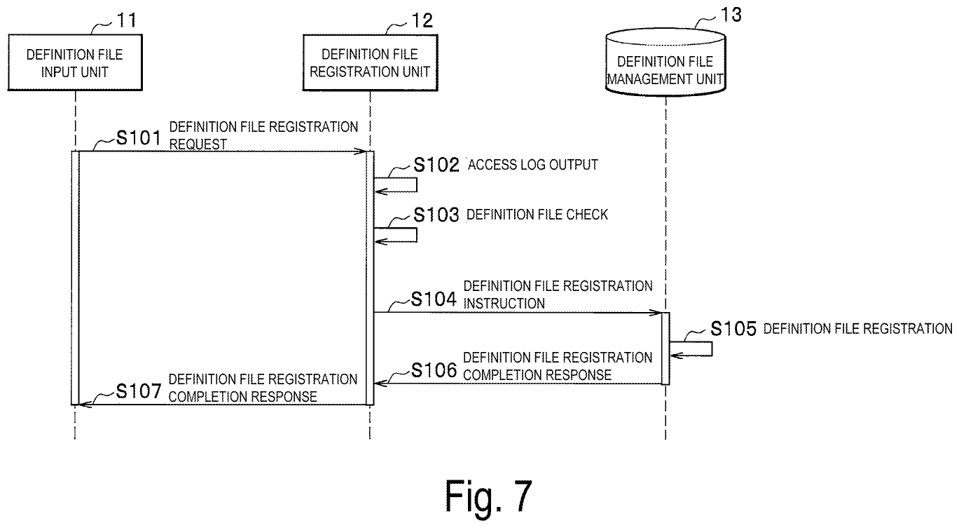

Hereinafter, details of a process of the catalog file creation assistance device 1 will be described with reference to sequence diagrams of FIG. 7 to FIG. 10.

First, a process of registering a definition file input by a definition file creator in the definition file management unit 13 will be described with reference to FIG. 7.

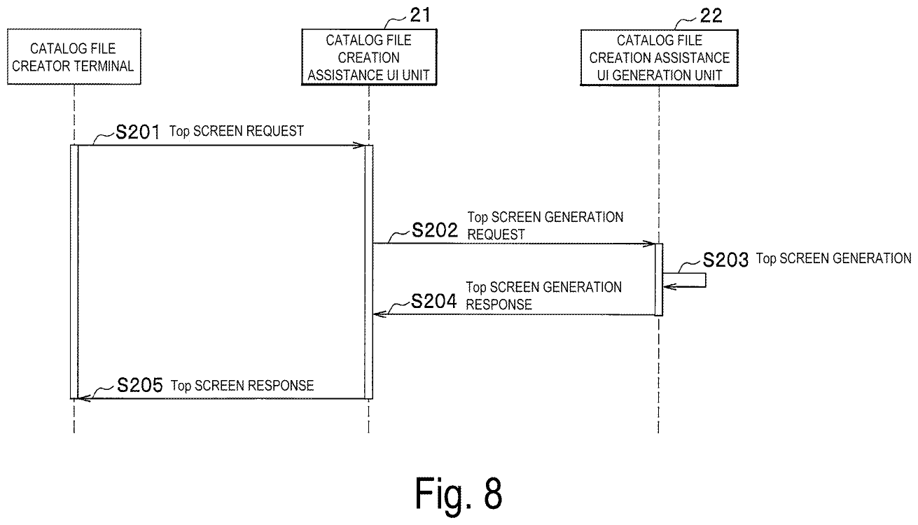

Then, a process in which the catalog file creator creates a catalog file via the form input screen 202 on the basis of the registered definition file will be described with reference to FIG. 8 to FIG. 10.

FIG. 7 is a sequence diagram illustrating a process of registering the definition file in the definition file management unit 13.

In S101, the definition file input unit 11 requests the definition file registration unit 12 to register the definition file.

In S102, the definition file registration unit 12 outputs an access log indicating the registration request in S101.

In S103, the definition file registration unit 12 parses the definition file in S101 to check a format such as the grammar.

In S104, the definition file registration unit 12 instructs the definition file management unit 13 to register the definition file.

In S105, the definition file management unit 13 receives the registration of the definition file.

In S106, the definition file management unit 13 responds to the definition file registration unit 12 reporting completion of the registration of the definition file.

In S107, the definition file registration unit 12 responds to the definition file input unit 11 reporting completion of the registration of the definition file.

FIG. 8 is a sequence diagram until the menu screen 211 is displayed.

In S201, a catalog file creator terminal requests the catalog file creation assistance UI unit 21 to provide a Top screen (the menu screen 211 in FIG. 4 and FIG. 5).

In S202, the catalog file creation assistance UI unit 21 requests the catalog file creation assistance UI generation unit 22 to generate a Top screen.

In S203, the catalog file creation assistance UI generation unit 22 generates a Top screen in which a new create button, an update button, a deletion button, and an output button are located.

In S204, the catalog file creation assistance UI generation unit 22 responds to request of the catalog file creation assistance UI unit 21 for the generation of the Top screen.

In S205, the catalog file creation assistance UI unit 21 responds to the catalog file creator terminal with the Top screen.

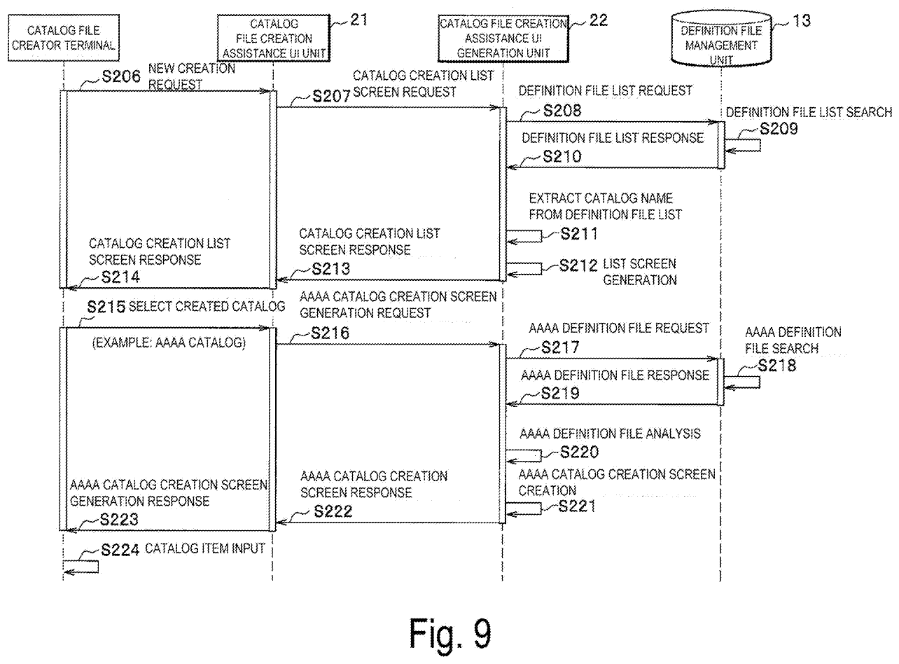

FIG. 9 is a sequence diagram until the catalog creation screen 215 is displayed from the menu screen 211 displayed in a process of FIG. 8.

In S206, when the new creation button is pressed on the menu screen 211, the catalog file creator terminal requests the catalog file creation assistance UI unit 21 to perform new creation.

In S207, the catalog file creation assistance UI unit 21 requests the catalog file creation assistance UI generation unit 22 to provide the catalog creation list screen 212 in FIG. 4.

In S208, the catalog file creation assistance UI generation unit 22 requests the definition file management unit 13 to provide the definition file list.

In S209, the definition file management unit 13 searches for the definition file list.

In S210, the definition file management unit 13 responds to the catalog file creation assistance UI generation unit 22 with the definition file list.

In S211, the catalog file creation assistance UI generation unit 22 extracts the catalog name from the definition file. For example, a catalog name “AAAA catalog” in row number 1 in the definition file of FIG. 6 is extracted.

In S212, the catalog file creation assistance UI generation unit 22 generates a list screen.

In S213, the catalog file creation assistance UI generation unit 22 responds to the catalog file creation assistance UI unit 21 with the catalog creation list screen 212.

In S214, the catalog file creation assistance UI unit 21 responds to the catalog file creator terminal with the catalog creation list screen 212.

In S215, the catalog file creator terminal allows the created catalog (for example, the AAAA catalog) to be selected via the catalog file creation assistance UI unit 21.

In S216, the catalog file creation assistance UI unit 21 requests the catalog file creation assistance UI generation unit 22 to generate an AAAA catalog creation screen 213 in FIG. 4.

In S217, the catalog file creation assistance UI generation unit 22 requests the definition file management unit 13 to provide an AAAA catalog definition file.

In S218, the definition file management unit 13 searches for the definition file of the AAAA catalog. For example, because row number 1 within the definition file in FIG. 6 matches the AAAA catalog of a search key, the definition file in FIG. 6 is extracted as a search result.

In S219, the definition file management unit 13 responds to the catalog file creation assistance UI generation unit 22 with the AAAA catalog definition file.

In S220, the catalog file creation assistance UI generation unit 22 analyzes the definition file of the AAAA catalog.

In S221, the catalog file creation assistance UI generation unit 22 generates the AAAA catalog creation screen 213.

In S222, the catalog file creation assistance UI generation unit 22 responds to the catalog file creation assistance UI unit 21 with the AAAA catalog creation screen 213.

In S223, the catalog file creation assistance UI unit 21 responds to the catalog file creator terminal in response to the request for generation of the AAAA catalog creation screen 213.

In S224, the catalog file creator terminal receives an input of a catalog item.

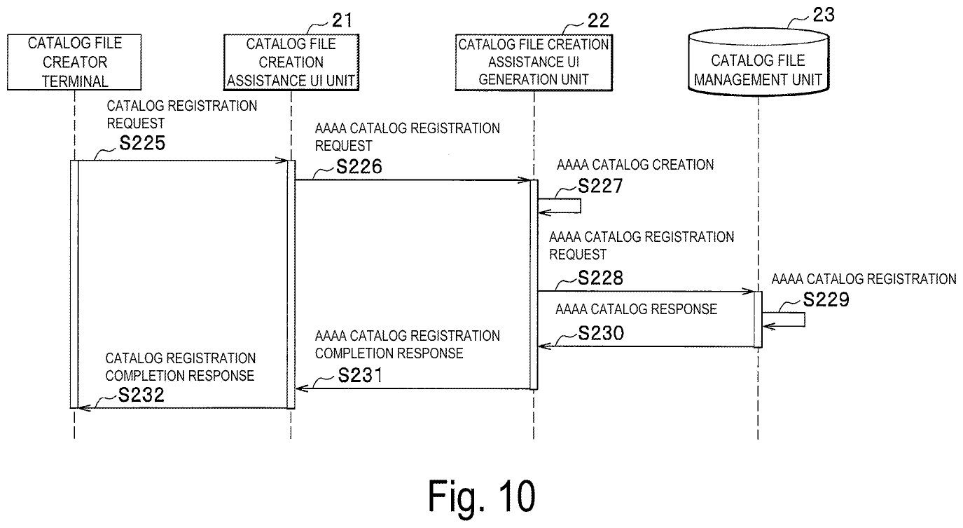

FIG. 10 is a sequence diagram until the catalog file created on the catalog creation screen 213 displayed in the process of FIG. 9 is registered in the catalog file management unit 23.

In S225, the catalog file creator terminal requests the catalog file creation assistance UI unit 21 to register the catalog created on catalog creation screen 213.

In S226, the catalog file creation assistance UI unit 21 requests the catalog file creation assistance UI generation unit 22 to register the AAAA catalog.

In S227, the catalog file creation assistance UI generation unit 22 substitutes the definition file of the AAAA catalog with each item entered on the catalog creation screen 213, thereby generating the AAAA catalog.

In S228, the catalog file creation assistance UI generation unit 22 requests the catalog file management unit 23 to register the AAAA catalog in S227.

In S229, the catalog file management unit 23 receives the registration of the AAAA catalog.

In S230, the catalog file management unit 23 responds to the catalog file creation assistance UI generation unit 22 with completion of the registration of the AAAA catalog.

In S231, the catalog file creation assistance UI generation unit 22 responds to the catalog file creation assistance UI unit 21 reporting the completion of the registration of the AAAA catalog.

In S232, the catalog file creation assistance UI unit 21 responds to the catalog file creator terminal reporting the completion of the catalog registration. Accordingly, a message screen 216 in FIG. 4 illustrating registration completion is displayed on the catalog file creator terminal.

In the embodiment described above, the catalog file creation assistance UI unit 21 receives input data of the catalog file from the catalog file creator, and registers the catalog file created on the basis of the input data in the catalog file management unit 23. Here, the catalog file creation assistance UI generation unit 22 loads the definition file prepared in the definition file management unit 13 in advance, and creates the catalog creation screen 213 to be provided by the catalog file creation assistance UI unit 21. Definition data such as “type property”, “default value”, and “candidate value” of the catalog file is described in the definition file in advance, and the catalog creation screen 213 is generated in a form suitable for the definition data.

This prevents an input error because the catalog file creator no longer needs to directly input the entire catalog file as one text file.

Further, the catalog file creation assistance UI generation unit 22 interlinks editing work between catalog files on the basis of link data indicating a relationship between the catalog files described in the definition file. For example, transition from the catalog creation screen 213 of the catalog file (the AAAA catalog) to be currently created to the catalog creation screen 215 of another relevant catalog file (the BBBB catalog) occurs.

This assists editing work of a plurality of relevant catalog files even if the catalog file operator does not know the relationship between the catalog files.

In the embodiment, the catalog file creation assistance device 1 according to the present invention is a device that receives an input from the catalog file creator terminal or a definition file creator terminal as illustrated in FIG. 1, but the present invention is not limited to these numbers or configurations. Further, the present invention can be realized by a program causing hardware resources of a general computer to operate as each unit of the catalog file creation assistance device 1. The program may also be distributed over a communications line, or may be recorded and distributed on a recording medium such as CD-ROM.

### REFERENCE SIGNS LIST

1 Catalog file creation assistance device
11 Definition file input unit
12 Definition file registration unit
13 Definition file management unit
21 Catalog file creation assistance UI unit (screen input unit)
22 Catalog file creation assistance UI generation unit (screen generation unit)
23 Catalog file management unit

1. A catalog file creation assistance device comprising:
a definition file management unit configured to store, for each catalog file to be created, a definition file, the definition file defining information of a catalog file relevant to a catalog file to be created, and an attribute described in the catalog file to be created;
a screen generation unit configured to generate a catalog creation screen for each catalog file to be created by referring to the definition file, the catalog creation screen including i) a link for calling the catalog creation screen for creating the relevant catalog files, and ii) an input field for each attribute described in the catalog file to be created; and
a screen input unit configured to:
receive an input of an attribute value in the input field for each attribute via the catalog creation screen, and
register the catalog file to be created including the received attribute value in a catalog file management unit.

2. The catalog file creation assistance device according to claim 1, wherein a catalog file, which becomes part of components of the catalog file to be created, is described in the definition file as information of the relevant catalog file.

3. The catalog file creation assistance device according to claim 1, wherein a catalog file having an attribute value, which is referred to by the catalog file to be created, is described in the definition file as information of the relevant catalog files.

4. The catalog file creation assistance device according to claim 1, wherein requirement information indicating whether description in the catalog file is required for each attribute is defined in the definition file, and
the screen generation unit displays an attribute included in the catalog creation screen to be created, with the requirement information added.

5. The catalog file creation assistance device according to claim 1,
wherein a plurality of candidate values that are taken for each attribute are defined in the definition file, and
the screen generation unit sets an input field for an attribute included in the catalog creation screen to be created, as an input field for selecting one candidate value from the plurality of candidate values.

6. A catalog file creation assistance method executed in a catalog file creation assistance device including a definition file management unit, a screen generation unit, and a screen input unit, the catalog file creation assistance method comprising:
storing, for each catalog file to be created, a definition file in the definition file management unit, the definition file defining information of a catalog file relevant to a catalog file to be created and an attribute described in the catalog file to be created;
generating, by the screen generation unit, the catalog creation screen for each catalog file to be created by referring to the definition file, the catalog creation screen including a link for calling the catalog creation screen for creating the relevant catalog files, and an input field for each attribute described in the catalog file to be created; and
receiving, by the screen input unit, an input of an attribute value in the input field for each attribute via the catalog creation screen, and registering the catalog file to be created including the received attribute value in a catalog file management unit.

7. A catalog file creation assistance program for causing a catalog file creation assistance device to execute a catalog file creation assistance method, the catalog file creation assistance device being a computer, the catalog file creation assistance method comprising:
storing, for each catalog file to be created, a definition file in a definition file management unit, the definition file defining information of a catalog file relevant to a catalog file to be created and an attribute described in the catalog file to be created;
generating, by a screen generation unit, a catalog creation screen for each catalog file to be created by referring to the definition file, the catalog creation screen including a link for calling the catalog creation screen for creating the relevant catalog files, and an input field for each attribute described in the catalog file to be created; and
receiving, by a screen input unit, an input of an attribute value in the input field for each attribute via the catalog creation screen, and registering the catalog file to be created including the received attribute value in a catalog file management unit.
